(19) United States
(12) Patent Application Publication
(10) Pub. No.: US 2009/0081603 A1
(43) Pub. Date: Mar. 26, 2009

(54) Orthodontic Bracket

(76) Inventor: Rolf Forster, Pforzheim (DE)

Correspondence Address: WALTER A. HACKLER, Ph.D.;PATENT LAW OFFICE, Suite B, 2372 S.E. Bristol Street, New Port, CA, 92660-0755, US

(21) Appl. No.: 12/231,122

(22) Filed: Aug. 29, 2008

(30) Foreign Application Priority Data
Sep. 21, 2007 (DE) 10 2007 046 383.0

(51) Int. Cl. A61C 7/14; A61C 7/16; A61C 7/28

(52) U.S. Cl. 433/10; 433/8

(57) ABSTRACT

Then invention relates to an orthodontic bracket comprised of a base (2) for the fastening on a tooth and a bent yoke (3a) that can swivel between an open position, in which between the base (2) and a free end of the yoke (3a) is space for the inserting of a wire (4), and a closed position in which the yoke (3a) embraces an inserted wire (4), that is then held between said yoke and the base.

Pursuant to the invention it is provided that on the base (2) is fastened a holding tongue (5) for the twisting-resistant holding of a wire (4) embraced by the yoke (3a).

Such brackets have been known for many years. A great advantage of such brackets consists in that they can be very easily manufactured by welding a metal strip to a base plate. The metal strip is provided with a bent section at one of its extremities to form a yoke as a holding element. Inasmuch as the metal strip is pliable and can be bent, this yoke can swivel between an open position, in which a wire can be inserted between a free end of the yoke and the base plate, and a closed position in which the yoke embraces an inserted wire, that is then held between said yoke and the base.

Such brackets have been widely used by orthodontists for more than 25 years and are highly valued due to their ease of operation. The advantage of such brackets for patients is that they are very flat, thus rendering a high comfort when wearing them, especially when a lingual bracket is used.

However, such a type of bracket transfers torques into only two directions, wherefore such brackets are sometimes also called 2-D brackets.

Brackets that facilitate a transfer of torque into three directions are known from prior art in many forms, e.g., from US 2005/0019719 A1, US 2002/0034715 A1, U.S. Pat. No. 4,669,980, and EP 1 332 726 A1. Such brackets are, however, much more expensive to manufacture, much more difficult to handle by the orthodontist and offer a lower wearing comfort because they cannot be manufactured as flat.

### SUMMARY OF THE INVENTION

It is an object of the invention to provide a bracket of simple construction, as initially set forth, by which a torque can be applied on teeth in three directions without impairing the wearing comfort or to render the handling by the orthodontist considerably more difficult.

In accordance with the invention, this object is attained by a bracket with the features set forth in claim 1. Other advantageous embodiments of the invention are object of the dependent claims.

By adding a holding tongue to a known bracket, it is possible to achieve in an ingeniously easy manner that, via the bracket, torques can be transferred into three directions. By using a wire with a rectangular or almost rectangular cross-section it is possible to preset the direction of the wire with respect to the base of the bracket. By means of the holding tongue it is possible to prevent the twisting or tilting of the wire so that a torque can be applied to the tooth in an additional direction. In such a manner it is possible not only to correct a rotation of the tooth around its longitudinal axis and a lateral tipping but also the inclination angle of a tooth, which is called “torquing.”

The amazingly simple solution, to add a holding tongue to a known bracket increases only insignificantly the manufacturing costs of a bracket. To wit, the holding tongue can be configured as a metal strip of which a section is rigidly attached to the base, preferably by welding. The wearing comfort is not impaired by a holding tongue according to the invention because it does not change the dimensions of the bracket, in particular vertical to the base.

With a bracket according to the invention, orthodontists can treat misalignments of a tooth that require a torquing of the teeth just as easily as misalignments that only require a shifting, a longitudinal rotating or a tipping of teeth. The orthodontist's customary movement for the inserting of a bracing wire below an open yoke of a bracket can also be used for a bracket according to the invention for the inserting of the wire underneath the holding tongue. Additional procedural steps are therefore not necessary.

In principle, the holding tongue could retain a wire by clamping. Preferably, however, the holding tongue is made out of a hard material and rigidly attached to the base. A square wire, whose thickness is less than, e.g., 0.01 mm or 0.02 mm of the distance between the base and the holding tongue can be problem-free inserted between the base and the holding tongue. A twisting of the wire is prevented because this would require a bending up of the holding tongue which, because of the hardness of the holding tongue, would require very strong forces. By way of example, the holding tongue can be made out of hardened stainless steel, especially strain-hardened steel, in order to withstand the forces originating in orthodontic treatments.

The yoke of a bracket according to the invention can be configured as a bent section of a strip that is affixed with a flat section to the base.

By bending the metal strip, the yoke can then be swiveled between an open position and a closed position. Preferably, the yokes are made out of a softer material than the holding tongue, such as, e.g., soft-annealed stainless steel, and are therefore more pliable than the holding tongue.

### BRIEF DESCRIPTION OF THE DRAWINGS

Other details and advantages of the invention are explained by way of an embodiment with reference to the accompanying drawings. The therein described features can be made object of the claims either individually or in a combination of same, wherein:

FIG. 1 shows a diagonal view of a bracket with a bracing wire;

FIG. 2 shows a top view of the illustrated bracket; and

FIG. 3 shows a lateral view of the illustrated bracket.

### DETAILED DESCRIPTION

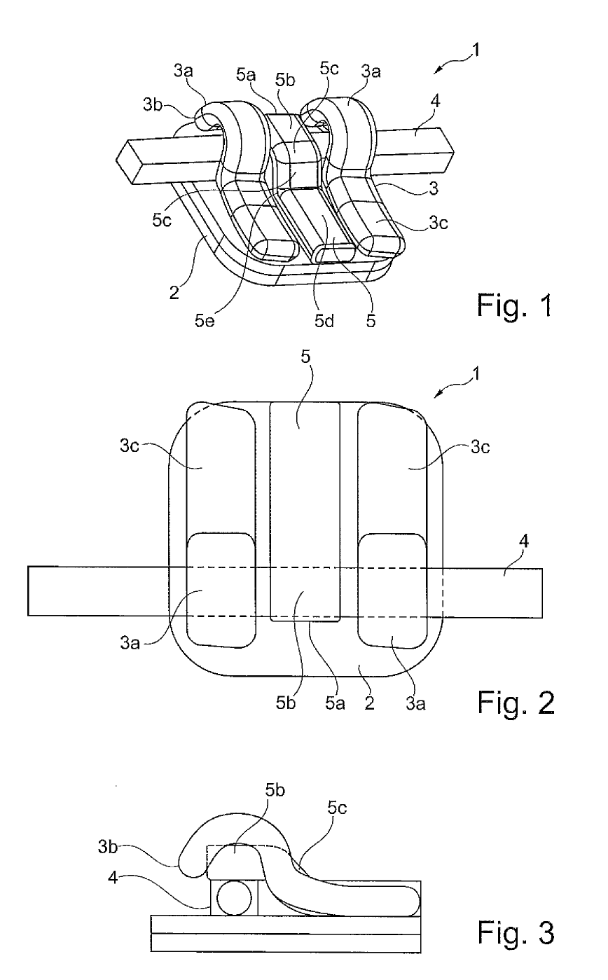

The bracket 1, illustrated in FIG. 1, has a base 2 configured as a base plate for fastening to a tooth, and two holding or retaining elements in form of curved yokes 3a, each of which is configured as a bent section of a strip 3. The yokes 3a can swivel between an open position, shown in FIG. 3, in which between the base plate 2 and a free extremity 3b of the yoke 3a is enough space for the inserting of a wire 4, and a closed position in which the yoke 3a embraces an inserted wire 4 that is then held between the yoke and the base plate 2. At the swiveling of the yoke 3a, the strip 3 of which a section 3c is attached to the base plate 2, preferably by welding, is bent. The strip 3 is preferably made out of soft-annealed stainless steel so that the bending of the yoke 3a, required for the inserting of the wire 4, is easily possible.

The yokes 3a prevent in their closed position that, transversally to its longitudinal direction, a wire 4 can move parallel to the base plate 2. However, the pliable yokes 3a cannot prevent a twisting of the wire 4 with respect to the base plate 2. Therefore, the illustrated bracket 1 is additionally provided with a holding tongue 5 in order to counteract a twisting or tilting of a wire 4 held by the yokes 3a. The holding tongue 5 is a metal strip, arranged between the two yokes 3a made out of, e.g., strain-hardened steel. The rigid holding tongue 5 is provided with a fastening section 5d by means of which it is rigidly attached to the base plate 2, preferably by welding or soldering.

The holding tongue 5 has a free end 5a with a thereto adjacent holding section 5b between which and the base 2, according to specifications, extends a wire 4 held by the bracket 1, namely a wire 4 held by the yokes 3a. The holding section 5b runs parallel to the base plate 2 in order to counteract a twisting or tilting of a square wire 4, as shown in the illustrations.

Between the free end 5a of the holding tongue 5 and the base 2 is a clearance that renders it possible to insert a wire 4 underneath the holding tongue 5. The free end 5a of the holding tongue 5 is preferably rounded or slanted which facilitates the inserting of a wire 4.

As shown in FIG. 1, the holding tongue 5 is either kinked or bent. Preferably, the holding tongue 5 has two kinks 5e that are preferably parallel. In such a manner it is attained that both the holding section 5b as well as the fastening section 5d run parallel to the base plate.

In the illustrated embodiment, adjacent to the holding section 5b is provided a section 5c, running obliquely to the base plate 2, which section, in turn, changes to the fastening section 5d, resting on the base plate 2, that is rigidly joined to the base plate 2.

### REFERENCE NUMBERS LIST

1 Bracket
2 Base plate
3 Strip
3a Yoke
3b End of strip 3
3c Section
4 Wire
5. Holding tongue
5a End of the holding tongue
5b Holding section of the holding tongue
5c Intermediate section of the holding tongue
5d Fastening section of the holding tongue
5e Kink of the holding tongue

What is claimed is:

1. An orthodontic bracket comprising
a base for the fastening on a tooth and
a holding element for holding a wire, said holding element being a curved yoke that can swivel between an open position, in which between the base and a free end of the yoke is a clearance for the inserting of a wire, and a closed position in which the yoke embraces an inserted wire, that is then held between said yoke and the base,
wherein on the base is fastened a holding tongue for twisting-resistant holding of a wire embraced by the yoke.

2. A bracket according to claim 1, wherein the base is provided with two holding elements between which the holding tongue is arranged.

3. A bracket according to claim 1, wherein the holding element is configured as a curved section of a strip that is provided with a flat section by means of which it is fastened to the base.

4. A bracket according to claim 3, wherein at the swiveling of the holding element the strip is bent between the open position and the closed position.

5. A bracket according to claim 1, wherein the holding tongue is a metal strip.

6. A bracket according to claim 1, wherein the holding tongue is made out of a harder material than the holding element.

7. A bracket according to claim 6, wherein the yoke is made out of soft-annealed stainless steel and the holding tongue out of strain-hardened steel.

8. A bracket according to claim 1, wherein the holding tongue is provided with a holding section extending parallel to the base, between which and the base, pursuant to specifications, is held a wire.

9. A bracket according to claim 8, wherein the holding section extends at a distance from the base.

10. A bracket according to claim 8, wherein the holding section starts at a free end of the holding tongue that is arranged at a distance from the base.

11. A bracket according to claim 8, wherein a section running obliquely to the base extends between the holding section and the fastening section.

12. A bracket according to any claim 1, wherein the holding tongue is either kinked or bent.
